(19) United States
(12) Patent Application Publication
(10) Pub. No.: US 2022/0335387 A1
(43) Pub. Date: Oct. 20, 2022

(54) METHOD AND SYSTEM FOR CONFIGURING USER ONBOARDING IN A FINANCIAL ORGANIZATION

(71) Applicant: Signzy Technologies Private Limited, Mumbai (IN)

(72) Inventors: Ankit RATAN, Mumbai (IN); Arpit RATAN, Mumbai (IN); Ankur PANDEY, Mumbai (IN)

(73) Assignee: Signzy Technologies Private Limited, Mumbai (IN)

(21) Appl. No.: 17/721,794

(22) Filed: Apr. 15, 2022

(30) Foreign Application Priority Data
Apr. 15, 2021 (IN) 202121017501

(51) Int. Cl. G06Q 10/10; G06Q 10/06

(52) U.S. Cl. CPC G06Q 10/1053; G06Q 10/0635

(57) ABSTRACT

The present disclosure provides a generic onboarding system, which performs a method for configuring user onboarding in a financial organization. The generic onboarding system enables the financial organization to select a set of rules from a plurality of rules. In addition, the generic onboarding system receives the set of rules associated with the financial organization. Further, the generic onboarding system enables automation of onboarding process for the user on the platform associated with the financial organization. Furthermore, the generic onboarding system performs a set of actions by a decision engine. Moreover, the generic onboarding system renders a decision taken by the decision engine for onboarding the user on the platform associated with the financial organization.

### TECHNICAL FIELD

The present invention relates to the technical field of user onboarding, and in particular, provides a method and system for configuring user onboarding in a financial organization.

### INTRODUCTION

Over the last few years, there has been a significant rise in Internet-based systems and other computer systems that facilitate onboarding of users in a financial organization. While onboarding the users, number of documents have to be reviewed, processed, stored and transformed into computer-readable data by the financial organization for providing financial services. For an example, documents include passport, birth certificate, driving license, society welfare card, income tax card, domicile card, voter ID card, electricity bill, water consumption, gas consumption bill, rent agreement and telephone bill. The financial services include opening a new savings account, opening a new current account, applying for home loan, business loan, or any type of loan and the like. Generally, these documents contain data that has to be extracted in order to onboard the user. Data contains information about the user. Conventionally, the financial organization has to review the documents manually that are subject to compliance that requires a reviewer to manually review each document, albeit on a computer screen, and determine whether the documents comply with the organization rules and government regulations. In addition, inconsistency of onboarding practices and lack of a standardized data collection approach have created redundancy, re-work, delays, and errors downstream processing functions.

### SUMMARY

In first example, a computer system is provided. The computer system includes one or more processors and a memory coupled to the one or more processors. The memory stores instructions. The instructions are executed by the one or more processors. The execution of instruction enables the one or more processors to perform a method for configuring user onboarding in a financial organization. The method includes a first step of enabling the financial organization to select a set of rules from a plurality of rules at a generic onboarding system. In addition, the method includes a second step of receiving the set of rules associated with the financial organization plurality of rules is a combination of one or more type of user onboarding rules. Further, the method includes a third step of enabling automation of onboarding process for the user on the platform associated with the financial organization. Furthermore, the method includes a fourth step of performing a set of actions by a decision engine. The decision engine evaluates one or more user documents corresponding to the set of rules selected by the financial organization. Moreover, the method includes a fifth step of rendering a decision taken by the decision engine for onboarding the user on the platform associated with the financial organization. The set of rules are selected based on financial service to be provided by the financial organization. The set of rules are selected by the financial organization in real time and dynamically. In addition, the financial organization selects the set of rules on one or more input sources. The set of rules are evaluated for user onboarding on a platform associated with the financial organization. The user is onboarded on the platform for the financial service requested by the user. Further, the set of rules are received from the one or more input sources. The automation is enabled using an execution engine associated with the generic onboarding system. The execution engine executes the set of rules of associated with the financial organization. Furthermore, the execution engine follows a custom flow for execution of the set of rules selected by the financial organization. The custom flow is a sequence for implementation of the set of rules. The decision engine generates a risk score report corresponding to the user based on the evaluation of the one or more user documents. The risk score report is generated using one or more hardware run algorithms. Moreover, the decision includes one of safe, unsafe or risky based on the evaluation of the one or more user documents. The set of actions includes one of onboarding user, rejecting user and flagging user.

In an embodiment of the present disclosure, the generic onboarding system reduces the turnaround time and onboarding cost for user onboarding on the platform associated with the financial organization. In addition, the turnaround time and cost for user onboarding is reduced by automating the user onboarding process.

In an embodiment of the present disclosure, the user interacts with a custom implementation of the generic onboarding system. In addition, the custom implementation of the generic onboarding system is based on the financial service to be provided by the financial organization. Further, the user uploads the one or more user documents associated with the user to the custom implementation of the generic onboarding system. Furthermore, the one or more user documents are identification documents associated with the user. Moreover, the one or more user documents are received in one or more input formats.

In an embodiment of the present disclosure, the one or more input formats include at least one of text, image, audio, video, gif, and animation.

In an embodiment of the present disclosure, the one or more input sources includes at least one of manual forms filled by the user, web-based forms, mobile application based forms, and data from third-party offline and online sources.

In an embodiment of the present disclosure, the generic onboarding system provides an interface to the financial organization to interact with the generic onboarding system using a virtual assistant. In addition, the virtual assistant provides complete assistance to the financial organization to create the custom implementation of the generic onboarding system.

In an embodiment of the present disclosure, the plurality of rules includes at least one of a first set of rules, a second set of rules and a third set of rules.

In an embodiment of the present disclosure, the first set of rules includes at least one of email verification, ID verification, bank account verification, account verification, GSTN verification, ROC CIN/FSSAI, employment verification, AML/CFT, and court cases.

In an embodiment of the present disclosure, the second set of rules includes at least one of document tagging, image forensics, forgery check, face match, name, address, video verification, geo coordinates and time & date.

In an embodiment of the present disclosure, the third set of rules includes at least one of credit score, CRILIC check, shop image match, additional documents, custom-name matching log, RM ID check, declarations, data clean and strike off companies.

In second example, a computer implemented method is provided. The computer implemented method for configuring user onboarding in a financial organization. The method includes a first step of enabling the financial organization to select a set of rules from a plurality of rules at a generic onboarding system. In addition, the method includes a second step of receiving the set of rules associated with the financial organization plurality of rules is a combination of one or more type of user onboarding rules. Further, the method includes a third step of enabling automation of onboarding process for the user on the platform associated with the financial organization. Furthermore, the method includes a fourth step of performing a set of actions by a decision engine. The decision engine evaluates one or more user documents corresponding to the set of rules selected by the financial organization. Moreover, the method includes a fifth step of rendering a decision taken by the decision engine for onboarding the user on the platform associated with the financial organization. The set of rules are selected based on financial service to be provided by the financial organization. The set of rules are selected by the financial organization in real time and dynamically. In addition, the financial organization selects the set of rules on one or more input sources. The set of rules are evaluated for user onboarding on a platform associated with the financial organization. The user is onboarded on the platform for the financial service requested by the user. Further, the set of rules are received from the one or more input sources. The automation is enabled using an execution engine associated with the generic onboarding system. The execution engine executes the set of rules of associated with the financial organization. Furthermore, the execution engine follows a custom flow for execution of the set of rules selected by the financial organization. The custom flow is a sequence for implementation of the set of rules. The decision engine generates a risk score report corresponding to the user based on the evaluation of the one or more user documents. The risk score report is generated using one or more hardware run algorithms. Moreover, the decision includes one of safe, unsafe or risky based on the evaluation of the one or more user documents. The set of actions includes one of onboarding user, rejecting user and flagging user.

In an embodiment of the present disclosure, the generic onboarding system reduces the turnaround time and onboarding cost for user onboarding on the platform associated with the financial organization. In addition, the turnaround time and cost for user onboarding is reduced by automating the user onboarding process.

In an embodiment of the present disclosure, the user interacts with a custom implementation of the generic onboarding system. In addition, the custom implementation of the generic onboarding system is based on the financial service to be provided by the financial organization. Further, the user uploads the one or more user documents associated with the user to the custom implementation of the generic onboarding system. Furthermore, the one or more user documents are identification documents associated with the user. Moreover, the one or more user documents are received in one or more input formats.

In an embodiment of the present disclosure, the one or more input formats include at least one of text, image, audio, video, gif, and animation.

In an embodiment of the present disclosure, the one or more input sources includes at least one of manual forms filled by the user, web-based forms, mobile application based forms, and data from third-party offline and online sources.

In an embodiment of the present disclosure, the generic onboarding system provides an interface to the financial organization to interact with the generic onboarding system using a virtual assistant. In addition, the virtual assistant provides complete assistance to the financial organization to create the custom implementation of the generic onboarding system.

In third example, a non-transitory computer readable storage medium is provided. The non-transitory computer-readable storage medium encodes computer executable instructions that, when executed by at least one processor, performs a method for configuring user onboarding in a financial organization. The method includes a first step of enabling the financial organization to select a set of rules from a plurality of rules at a generic onboarding system. In addition, the method includes a second step of receiving the set of rules associated with the financial organization plurality of rules is a combination of one or more type of user onboarding rules. Further, the method includes a third step of enabling automation of onboarding process for the user on the platform associated with the financial organization. Furthermore, the method includes a fourth step of performing a set of actions by a decision engine. The decision engine evaluates one or more user documents corresponding to the set of rules selected by the financial organization. Moreover, the method includes a fifth step of rendering a decision taken by the decision engine for onboarding the user on the platform associated with the financial organization. The set of rules are selected based on financial service to be provided by the financial organization. The set of rules are selected by the financial organization in real time and dynamically. In addition, the financial organization selects the set of rules on one or more input sources. The set of rules are evaluated for user onboarding on a platform associated with the financial organization. The user is onboarded on the platform for the financial service requested by the user. Further, the set of rules are received from the one or more input sources. The automation is enabled using an execution engine associated with the generic onboarding system. The execution engine executes the set of rules of associated with the financial organization. Furthermore, the execution engine follows a custom flow for execution of the set of rules selected by the financial organization. The custom flow is a sequence for implementation of the set of rules. The decision engine generates a risk score report corresponding to the user based on the evaluation of the one or more user documents. The risk score report is generated using one or more hardware run algorithms. Moreover, the decision includes one of safe, unsafe or risky based on the evaluation of the one or more user documents. The set of actions includes one of onboarding user, rejecting user and flagging user.

In an embodiment of the present disclosure, the generic onboarding system reduces the turnaround time and onboarding cost for user onboarding on the platform associated with the financial organization. In addition, the turnaround time and cost for user onboarding is reduced by automating the user onboarding process.

In an embodiment of the present disclosure, the generic onboarding system provides an interface to the financial organization to interact with the generic onboarding system using a virtual assistant. In addition, the virtual assistant provides complete assistance to the financial organization to create the custom implementation of the generic onboarding system.

In an embodiment of the present disclosure, the plurality of rules includes at least one of a first set of rules, a second set of rules and a third set of rules.

### BRIEF DESCRIPTION OF THE DRAWINGS

Having thus described the invention in general terms, reference will now be made to the accompanying drawings, which are not necessarily drawn to scale, and wherein:

FIG. 1 illustrates an interactive computing environment for configuring user onboarding in a financial organization, in accordance with various embodiments of the present disclosure.

FIG. 2 illustrates a flow chart of the method for configuring user onboarding in a financial organization; in accordance with various embodiments of the present disclosure, and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

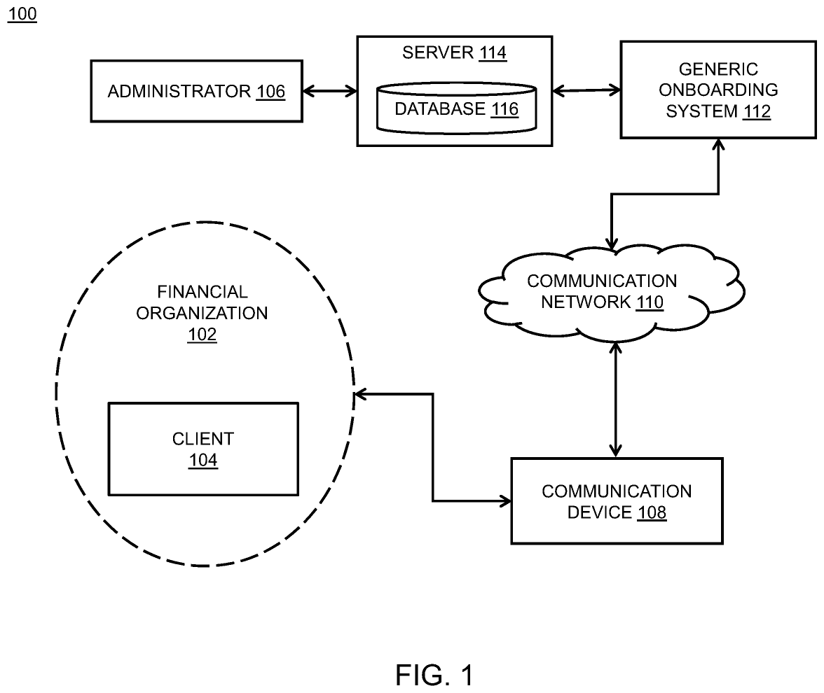

FIG. 1 illustrates an interactive computing environment 100 for configuring user onboarding in a financial organization 102, in accordance with various embodiments of the present disclosure. The interactive computing environment 100 includes the financial organization 102, a client 104, an administrator 106, a communication device 108 and a communication network 110. In addition, the interactive computing environment 100 includes a generic onboarding system 112, a server 114 and a database 116. The above stated elements of the interactive computing environment 100 operate coherently and synchronously to enable the configuring user onboarding in the financial organization 102.

The interactive computing environment 100 includes the client 104. The client 104 is any person that wants to offer one or more financial services to a user. In an embodiment of the present disclosure, the client 104 is any organization that wants to offer the one or more financial services to the user. In an example, the one or more financial services include onboarding of the user, opening a new savings account of the user, opening a new current account of the user. In addition, the one or more financial services include application for home loan, business loan, or any type of loan, opening a demat account and the like.

In an embodiment of the present disclosure, the client 104 programs the generic onboarding system 112 to train an artificial intelligence based decision engine. The client 104 selects a set of rules from a plurality of rules. The plurality of rules is a combination of one or more user onboarding rules. The relevant rules (or the set of rules) are selected based on the input parameters that are passed into the rule engine. A plurality of individual facts and rules are configured while configuring the onboard journey. The triggers for each individual rule unit decides when they get fired. The rules are configured as DAG.

The set of rules are evaluated for onboarding the user in the financial organization 102. In another embodiment of the present disclosure, the administrator 106 programs the generic onboarding system 112 to train the decision engine. In addition, the decision engine facilitates automation and understanding of the one or more financial services related to the financial organization 102.

The client 104 is any person that is associated with the financial organization 102. In an embodiment of the present disclosure, the client 104 connects with the generic onboarding system 112 using web-based application. In another embodiment of the present disclosure, the client 104 connects with the generic onboarding system 112 using mobile based application. In yet another embodiment of the present disclosure, the client 104 connects with the generic onboarding system 112 using desktop application. In yet another embodiment of the present disclosure, the client 104 connects with the generic onboarding system 112 using any other application of the like.

The interactive computing environment 100 includes the financial organization 102. The financial organization 102 is any organization that provides the one or more financial services to the user. In an embodiment of the present disclosure, the financial organization 102 includes one or more banks. In another embodiment of the present disclosure, the financial organization 102 includes one or more non-banking financial corporations. In yet another embodiment of the present disclosure, the financial organization 102 includes similar companies providing the one or more financial services to the user.

The interactive computing environment 100 includes the communication device 108. The communication device 108 is associated with the financial organization 102 and in turn associated with the client 104. The client 104 utilizes the communication device 108 to connect to the generic onboarding system 112. In an embodiment of the present disclosure, the communication device 108 is any smart device that mainly includes a display, camera and network connectivity. In an embodiment of the present disclosure, the communication device 108 is a portable communication device. In an example, the portable communication device includes laptop, smart phone, tablet, smart watch, and the like. In another embodiment of the present disclosure, the communication device 108 is a fixed communication device. In an example, the fixed communication device includes a desktop, a workstation PC and the like.

The communication device 108 performs computing operations based on a suitable operating system installed inside the communication device 108. In general, operating system is system software that manages computer hardware and software resources and provides common services for computer programs. In addition, the operating system acts as an interface for software installed inside the communication device 108 to interact with hardware components of the communication device 108.

In an embodiment of the present disclosure, the operating system installed inside the communication device 108 is a mobile operating system. In an embodiment of the present disclosure, the communication device 108 performs computing operations based on any suitable operating system designed for portable communication device. In an example, the mobile operating system includes but may not be limited to Windows operating system from Microsoft, Android operating system from Google, iOS operating system from Apple. In another example, the mobile operating system includes Symbian operating system from Nokia, Bada operating system from Samsung Electronics and BlackBerry operating system from BlackBerry. However, the operating system is not limited to above mentioned operating systems. In an embodiment of the present disclosure, the communication device 108 operates on any version of particular operating system of above mentioned operating systems.

In another embodiment of the present disclosure, the communication device 108 performs computing operations based on any suitable operating system designed for fixed communication device. In an example, the operating system installed inside the communication device 108 is Windows from Microsoft. In another example, the operating system installed inside the communication device 108 is macOS from Apple. In yet another example, the operating system installed inside the communication device 108 is Linux based operating system. In yet another example, the operating system installed inside the communication device 108 may be one of UNIX, Kali Linux, and the like. However, the operating system is not limited to above mentioned operating systems. In an embodiment of the present disclosure, the communication device 108 operates on any version of particular operating system of above mentioned operating systems.

The interactive computing environment includes the communication network 110. The communication device 108 of the client 104 connects to the generic onboarding system 112 through the communication network 110. In addition, the communication network 110 is a part of network layer responsible for connection of the communication device 108 to the generic onboarding system 112. Further, the communication network 110 may be any type of network. In an embodiment of the present disclosure, type of the communication network 110 is a wireless mobile network. In another embodiment of the present disclosure, type of the communication network 110 is a wired network with a finite bandwidth. In yet another embodiment of the present disclosure, type of the communication network 110 is a combination of the wireless and the wired network for the optimum throughput of data transmission. In yet another embodiment of the present disclosure, type of the communication network 110 is an optical fiber high bandwidth network that enables a high data rate with negligible connection drops.

Furthermore, the communication network 110 includes a set of channels. Moreover, each channel of the set of channels supports a finite bandwidth. The finite bandwidth of each channel of the set of channels is based on capacity of the communication network 110. Also, the communication device 108 possesses a unique machine address (hereinafter “MAC”). MAC uniquely identifies each of the communication device 108 over the communication network 110.

The interactive computing environment 100 includes the generic onboarding system 112. The generic onboarding system 112 configures the user onboarding in the financial organization 102. The generic onboarding system 112 configures the user onboarding in the financial organization 102 in real-time.

The generic onboarding system 112 receives the set of rules and a custom flow of the set of rules for execution of the set of rules associated with the financial organization 102. In an embodiment of the present disclosure, the client 104 selects the set of rules on the generic onboarding system 112. The client 104 selects the set of rules for making a custom implementation of the generic onboarding system 112 to onboard the user in the financial organization 102. In another embodiment of the present disclosure, the administrator 106 selects the set of rules on the generic onboarding system 112. The administrator 106 selects the set of rules for making the custom implementation of the generic onboarding system 112 to onboard the user in the financial organization 102.

The set of rules is evaluated for the user onboarding in the financial organization 102. The generic onboarding system 112 receives the set of rules associated with the financial organization 102 from one or more input sources. The one or more input sources includes at least one of manual forms filled by the financial organization 102, web-based forms, mobile application based forms, data from third-party offline and online sources, and the like. The set of rules includes at least one of verification rules (hereinafter “first set of rules”), artificial intelligence rules (hereinafter “second set of rules”), background check rules (hereinafter “third set of rules”), and the like.

Furthermore, the first set of rules includes at least one of email verification of the user, ID verification of the user, bank account verification of the user, account verification of the user and GSTN verification of the user. In addition, the first set of rules includes ROC CIN/FSSAI, employment verification of the user, AML/CFT, court cases of the user, and the like.

The second set of rules includes at least one of document tagging of the user, image forensics associated with the user, forgery check of the user, face match of the user and name verification of the user. In addition, the second set of rules include address verification of the user, video verification of the user, geo coordinates verification of the user, time and date verification, and the like.

The third set of rules includes at least one of credit score check of the user, CRILIC check of the user, shop image match of the user and additional documents associated with the user. In addition, the third set of rules includes custom-name matching log, RM ID check, declarations associated with the user, data clean, strike off companies, and the like.

The generic onboarding system 112 generates an execution engine based on the set of rules received by the generic onboarding system 112 associated with the financial organization 102. The execution engine is a computer program that executes a set of instructions following a workflow. The execution engine follows the custom flow for execution of the set of rules received by the generic onboarding system 112. The execution engine executes the set of rules using one or more hardware run algorithms. In an example, the generic onboarding system 112 receives email id verification of the user, name verification of the user and address verification of the user as the set of rules. The generic onboarding system 112 receives the set of rules form the financial organization 102 to onboard the user. The execution engine executes the set of rules on one or more user documents in the sequence selected by the financial organization 102.

The generic onboarding system 112 trains the decision engine using the one or more hardware run algorithms. The one or more hardware run algorithms includes machine learning algorithms, artificial intelligence algorithms, deep learning algorithms and the like. In general, decision engine is a mathematical algorithm trained using data and human expert input to replicate a decision an expert makes when provided with the same information. The decision engine processes the one or more user documents corresponding to the set of rules selected by the financial organization 102.

The decision engine evaluates the one or more user documents and generates a risk score report corresponding to the user. The decision engine generates the risk score report based on the evaluation of the one or more user documents. The overall risk score is a derivative of the individual risk scores for each of the constituent components of the decision engine. The set of rules are configured for the decision engine during the configuration of onboarding flows. The weightage of individual components rule sets along with arithmetic rules to calculate the final risk score are also configured with the onboarding flow.

The decision engine performs a set of actions based on the risk score in the risk score report generated by the decision engine. The set of actions includes one of onboarding the user, rejecting the user and flagging the user. The decision engine rejects the user when the risk score is above a predefined upper threshold value (Value A). The decision engine onboards the user when the risk score is below a predefined lower threshold value (Value C). The decision engine flags the user when the risk score is between the predefined upper threshold value and the predefined lower threshold value (between Value A and Value C).

The threshold value is determined by the business requirement and the business use case. The threshold value is chosen through a tradeoff analysis over the precision and recall that are deemed to be adequate to solve the defined use case. In addition, the decision engine facilitates automation and understanding of the one or more financial services related to the financial organization 102.

In addition, the predefined upper threshold value and the predefined lower threshold value vary based on requirement of the financial organization 102. In an embodiment of the present disclosure, the client 104 defines the predefined upper threshold value and the predefined lower threshold value based on requirement of the financial organization 102. In another embodiment of the present disclosure, the generic onboarding system 112 defines the predefined upper threshold value and the predefined lower threshold value based on requirement of the financial organization 102. In yet another embodiment of the present disclosure, the administrator 106 defines the predefined upper threshold value and the predefined lower threshold value based on requirement of the financial organization 102.

The generic onboarding system 112 calculates the risk score based on verification of data in the one or more user documents. The generic onboarding system 112 calculates the risk score based on the one or more hardware run algorithms. In an example, the generic onboarding system 112 calculates the risk score as per verification of details of the user in each of the one or more user documents uploaded by the user. The risk score increases after each successful check of information of the user in each of the one or more user documents uploaded by the user. The risk score facilitates in performing onboarding of the user in the financial organization 102.

The generic onboarding system 112 creates the custom implementation of the generic onboarding system 112. The generic onboarding system 112 creates the custom implementation of the generic onboarding system 112 in real-time. The generic onboarding system 112 creates the custom implementation of the generic onboarding system 112 based on type of financial service to be provided by the financial organization 102.

The user interacts with the custom implementation of the generic onboarding system 112. The user uploads the one or more user documents associated with the user to the custom implementation of the generic onboarding system 112. The one or more user documents are identification documents associated with the user. The one or more user documents are received in one or more input formats.

The one or more user documents includes Aadhaar card of the user, pan card of the user, passport of the user, birth certificate of the user, and driving license of the user. In addition, the one or more user documents include the social security card of the user, society welfare card of the user, income tax card of the user, and the like. The one or more user documents further includes ration card of the user, domicile card of the user, voter ID card of the user, and the like. The one or more user documents includes electricity bill of the user, water consumption bill of the user, gas consumption bill of the user, rent agreement of the user, telephone bill of the user and the like.

The extraction of information from the one or more documents includes a first step of field detection. The field detection includes receiving text output from the images through optical character recognition (OCR). The output of the first step is passed into a post processor stage. The post processor stage uses localization and content based filtration rules in order to correctly label each of the named entities. A final text that remains after filtration is assigned to the label and is considered the output for the particular label (field).

The one or more input formats include one or more multimedia formats. In an example, the user uploads the one or more user documents using the device. The device of the user is identical to the computing device of the client 104. In an example, the one or more multimedia formats include but may not be limited to TIFF, Bitmap, JPEG, GIF, PNG, EPS, RAW Image Files and PDF. In another example, the user scans driving license of the user using the device to upload at the custom implementation of the generic onboarding system 112. In another example, the user clicks picture of passport of the user. Further, the user uploads picture of passport at the custom implementation of the generic onboarding system 112 using the device.

The generic onboarding system 112 performs the set of actions by the decision engine. The decision engine evaluates the one or more user documents corresponding to the set of rules selected by the financial organization 102. The decision engine generates the risk score report corresponding to the user based on the evaluation of the one or more user documents. The risk score report is generated using the one or more hardware run algorithms. In addition, the generic onboarding system 112 renders a decision taken by the decision engine to onboard the user on the platform associated with the financial organization 102. The decision includes one of safe, unsafe or risky based on the evaluation of the one or more user documents.

In an embodiment of the present disclosure, the generic onboarding system 112 provides an interface to the client 104 to interact with the generic onboarding system 112 using a virtual assistant. The virtual assistant provides complete assistance to the client 104 to create the custom implementation of the generic onboarding system 112. The client 104 interacts with the generic onboarding system 112 using the virtual assistant. In general, virtual assistant is an advanced computer program that simulates a conversation with people using it over the internet. Further, virtual assistant uses advanced artificial intelligence, natural language processing, natural language understanding, and machine learning algorithms to learn and provide a personalized, conversational experience.

The generic onboarding system 112 provides an interface to the administrator 106 to interact with a customized portal. The administrator 106 interacts with the customized portal to manually review the risk score report and onboard the user. The customized portal provides the administrator 106 with relevant information critical to make decisions for user onboarding. In an example, the customized portal provides the administrator 106 with a flagged user. The customized portal provides the administrator 106 with a m is-match in names of the user in the one or more user documents. The administrator 106 manually reviews the user application and makes the decision to onboard the user.

In an embodiment of the present disclosure, the generic onboarding system 112 is installed at the server 114. In another embodiment of the present disclosure, the generic onboarding system 112 is installed in the communication device 108. In yet another embodiment of the present disclosure, the generic onboarding system 112 is installed in the computing device of the client 104.

The interactive computing environment 100 includes the server 114. The generic onboarding system 112 is associated with the server 114. In general, server is a computer program that provides service to another computer programs. In addition, server may provide various functionalities or services, such as sharing data or resources among multiple administrators, performing computation for an administrator and the like. In an embodiment of the present disclosure, the server 114 is at least one of dedicated server, cloud server, network server, virtual private server and the like. However, the server 114 is not limited to above mentioned servers.

In addition, the server 114 includes the database 116. In general, database is a collection of information that is organized so that it can be easily accessed, managed and updated. In an embodiment of the present disclosure, the database 116 is at least one of at least hierarchical database, network database, relational database, object-oriented database and the like. The database 116 provides storage location to the one or more user documents and data associated with the generic onboarding system 112. In an embodiment of the present disclosure, the database 116 provides storage location to all the data and information required by the generic onboarding system 112. In an example, the database 116 is connected to the server 114. The server 114 stores data in the database 116. The server 114 interacts with the database 116 to retrieve the stored data.

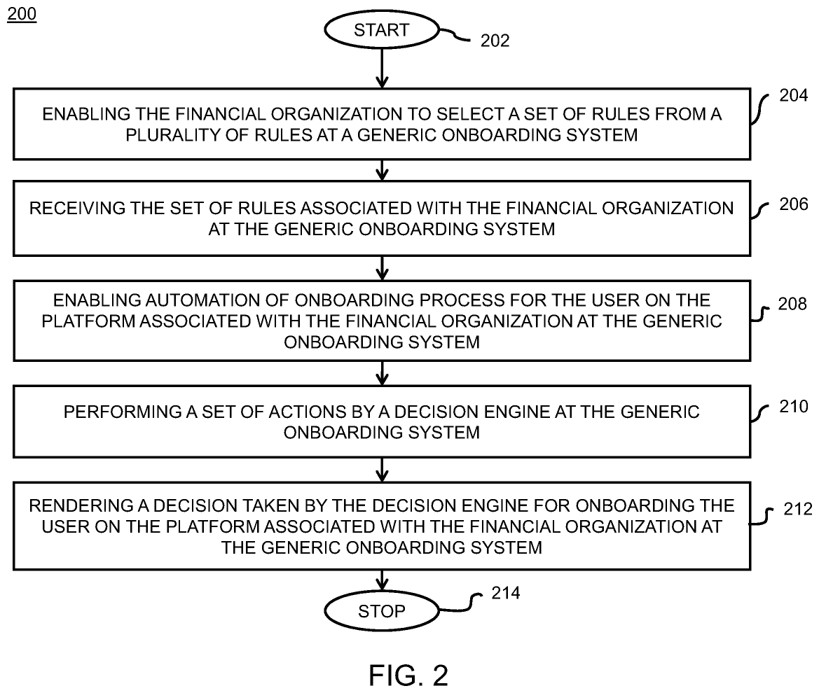

FIG. 2 illustrates a flow chart 200 of the method for configuring user onboarding in a financial organization 102, in accordance with various embodiments of the present disclosure. It may be noted that in order to explain the method steps of the flow chart 200, references will be made to the elements explained in FIG. 1. The flow chart 200 starts at step 202. At step 204, the financial organization 102 selects a set of rules from a plurality of rules at a generic onboarding system 112. At step 206, the generic onboarding system 112 receives the set of rules associated with the financial organization 102. At step 208, automation of onboarding process is enabled for the user on the platform associated with the financial organization 102 at the generic onboarding system 112. At step 210, a decision engine performs a set of actions at the generic onboarding system 112. At step 212, a decision taken by the decision engine is rendered to onboard the user on the platform associated with the financial organization 102.

The flow chart 200 terminates at step 214. It may be noted that the flow chart 200 is explained to have above stated process steps; however, those skilled in the art would appreciate that the flow chart 200 may have more/less number of process steps which may enable all the above stated embodiments of the present disclosure.

In an embodiment of the present disclosure, the plurality of rules is a combination of one or more type of user onboarding rules. The set of rules are selected on financial service provided by the financial organization 102. In addition, the financial organization 102 selects the set of rules dynamically and in real time. Further, the financial organization 102 selects the set of rules on one or more input sources. In an embodiment of the present disclosure, the set of rules are evaluated for user onboarding on a platform associated with the financial organization 102.

In addition, the user is onboarded on the platform for one or more financial services requested from the user. Further, the set of rules are received from the one or more input sources. In an embodiment of the present disclosure, the automation is enabled using an execution engine associated with the generic onboarding system 112. In addition, the execution engine executes the set of rules of associated with the financial organization 102. Further, the execution engine follows a custom flow for execution of the set of rules selected by the financial organization 102. Furthermore, the custom flow is a sequence for implementation of the set of rules.

In an embodiment of the present disclosure, the decision engine evaluates one or more user documents corresponding to the set of rules selected by the financial organization 102. In addition, the decision engine generated a risk score report corresponding to the user based on the evaluation of the one or more user documents. Further, the risk score report is generated using one or more hardware run algorithms. In an embodiment of the present disclosure, the decision includes one of sale, unsafe or risky based on the evaluation of the one or more user documents. In addition, the set of actions include one of an onboarding user, a rejecting user and a flagging user.

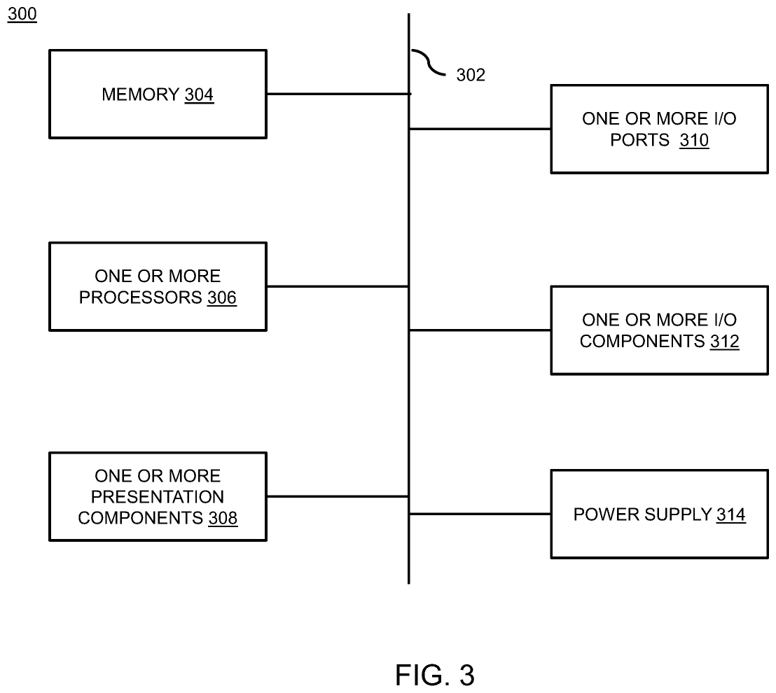

FIG. 3 illustrates a block diagram of a computing device 300, in accordance with various embodiments of the present disclosure. The computing device 300 represents internal hardware components of the communication device 108. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 2 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 2 is merely illustrative of an exemplary computing device 300. The computing device 300 that can be used in connection with one or more embodiments of the present invention. The distinction is not made between such categories as “workstation,” “server,” “laptop,” “hand-held device,” etc., as all are contemplated within the scope of FIG. 2 and reference to “communication device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer readable storage media and communication media. The computer readable storage media includes volatile and nonvolatile, removable and non-removable media implemented in any method or technology for storage of information such as computer-readable instructions, data structures, program modules or other data.

The computer-readable storage media with memory 304 includes, but is not limited to, non-transitory computer readable media that stores program code and/or data for longer periods of time such as secondary or persistent long term storage, like RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The computer-readable storage media associated with the memory 304 and/or other computer-readable media described herein can be considered computer readable storage media for example, or a tangible storage device. The communication media typically embodies computer-readable instructions, data structures, program modules or other data in a modulated data signal such as a carrier wave or other transport mechanism and in such a includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. The computing device 300 includes one or more processors that read data from various entities such as the memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer system comprising:
one or more processors; and
a memory coupled to the one or more processors, the memory for storing instructions which, when executed by the one or more processors, cause the one or more processors to perform a method for configuring user onboarding in a financial organization, the method comprising:
enabling, at a generic onboarding system, the financial organization to select a set of rules from a plurality of rules, wherein the plurality of rules is a combination of one or more type of user onboarding rules, wherein the set of rules are selected based on financial service to be provided by the financial organization, wherein the set of rules are selected by the financial organization in real time and dynamically, wherein the financial organization selects the set of rules on one or more input sources;
receiving, at the generic onboarding system, the set of rules associated with the financial organization, wherein the set of rules are evaluated for user onboarding on a platform associated with the financial organization, wherein the user is onboarded on the platform for the financial service requested by the user, wherein the set of rules are received from the one or more input sources;
enabling, at the generic onboarding system, automation of onboarding process for the user on the platform associated with the financial organization, wherein the automation is enabled using an execution engine associated with the generic onboarding system, wherein the execution engine executes the set of rules of associated with the financial organization, wherein the execution engine follows a custom flow for execution of the set of rules selected by the financial organization, wherein the custom flow is a sequence for implementation of the set of rules;
performing, at the generic onboarding system, a set of actions by a decision engine, wherein the decision engine evaluates one or more user documents corresponding to the set of rules selected by the financial organization, wherein the decision engine generates a risk score report corresponding to the user based on the evaluation of the one or more user documents, wherein the risk score report is generated using one or more hardware run algorithms; and
rendering, at the generic onboarding system, a decision taken by the decision engine for onboarding the user on the platform associated with the financial organization, wherein the decision comprises one of safe, unsafe or risky based on the evaluation of the one or more user documents, wherein the set of actions comprises one of onboarding user, rejecting user and flagging user.

2. The computer system as recited in claim 1, wherein the generic onboarding system reduces the turnaround time and onboarding cost for user onboarding on the platform associated with the financial organization, wherein the turnaround time and cost for user onboarding is reduced by automating the user onboarding process.

3. The computer system as recited in claim 1, wherein the user interacts with a custom implementation of the generic onboarding system, wherein the custom implementation of the generic onboarding system is based on the financial service to be provided by the financial organization, wherein the user uploads the one or more user documents associated with the user to the custom implementation of the generic onboarding system, wherein the one or more user documents are identification documents associated with the user, wherein the one or more user documents are received in one or more input formats.

4. The computer system as recited in claim 3, wherein the one or more input formats comprises at least one of text, image, audio, video, gif, and animation.

5. The computer system as recited in claim 1, wherein the one or more input sources comprises at least one of manual forms filled by the user, web-based forms, mobile application based forms, and data from third-party offline and online sources.

6. The computer system as recited in claim 1, wherein the generic onboarding system provides an interface to the financial organization for interacting with the generic onboarding system using a virtual assistant, wherein the virtual assistant provides complete assistance to the financial organization for creating the custom implementation of the generic onboarding system.

7. The computer system as recited in claim 1, wherein the plurality of rules comprising at least one of a first set of rules, a second set of rules and a third set of rules.

8. The computer system as recited in claim 7, wherein the first set of rules comprises at least one of email verification, ID verification, bank account verification, account verification, GSTN verification, ROC CIN/FSSAI, employment verification, AML/CFT, court cases, and the like.

9. The computer system as recited in claim 7, wherein the second set of rules comprises at least one of document tagging, image forensics, forgery check, face match, name, address, video verification, geo coordinates, time & date, and the like.

10. The computer system as recited in claim 7, wherein the third set of rules comprises at least one of credit score, CRILIC check, shop image match, additional documents, custom-name matching log, RM ID check, declarations, data clean, strike off companies, and the like.

11. A computer implemented method for configuring user onboarding in a financial organization, the method comprising:
enabling, at a generic onboarding system with the processor, the financial organization to select a set of rules from a plurality of rules, wherein the plurality of rules is a combination of one or more type of user onboarding rules, wherein the set of rules are selected based on financial service to be provided by the financial organization, wherein the set of rules are selected by the financial organization in real time and dynamically, wherein the financial organization selects the set of rules on one or more input sources;
receiving, at the generic onboarding system with the processor, the set of rules associated with the financial organization, wherein the set of rules are evaluated for user onboarding on a platform associated with the financial organization, wherein the user is onboarded on the platform for the financial service requested by the user, wherein the set of rules are received from the one or more input sources;
enabling, at the generic onboarding system with the processor, automation of onboarding process for the user on the platform associated with the financial organization, wherein the automation is enabled using an execution engine associated with the generic onboarding system, wherein the execution engine executes the set of rules of associated with the financial organization, wherein the execution engine follows a custom flow for execution of the set of rules selected by the financial organization, wherein the custom flow is a sequence for implementation of the set of rules;
performing, at the generic onboarding system with the processor, a set of actions by a decision engine, wherein the decision engine evaluates one or more user documents corresponding to the set of rules selected by the financial organization, wherein the decision engine generates a risk score report corresponding to the user based on the evaluation of the one or more user documents, wherein the risk score report is generated using one or more hardware run algorithms; and
rendering, at the generic onboarding system with the processor, a decision taken by the decision engine for onboarding the user on the platform associated with the financial organization, wherein the decision comprises one of safe, unsafe or risky based on the evaluation of the one or more user documents, wherein the set of actions comprises one of onboarding user, rejecting user and flagging user.

12. The computer implemented method as claimed in claim 11, wherein the generic onboarding system reduces the turnaround time and onboarding cost for user onboarding on the platform associated with the financial organization, wherein the turnaround time and cost for user onboarding is reduced by automating the user onboarding process.

13. The computer implemented method as claimed in claimed 11, wherein the user interacts with a custom implementation of the generic onboarding system, wherein the custom implementation of the generic onboarding system is based on the financial service to be provided by the financial organization, wherein the user uploads the one or more user documents associated with the user to the custom implementation of the generic onboarding system, wherein the one or more user documents are identification documents associated with the user, wherein the one or more user documents are received in one or more input formats.

14. The computer implemented method as claimed in claim 13, wherein the one or more input formats comprises at least one of text, image, audio, video, gif, and animation.

15. The computer implemented method as claimed in claim 11, wherein the one or more input sources comprises at least one of manual forms filled by the user, web-based forms, mobile application based forms, and data from third-party offline and online sources.

16. The computer implemented method as claimed in claim 11, wherein the generic onboarding system provides an interface to the financial organization for interacting with the generic onboarding system using a virtual assistant, wherein the virtual assistant provides complete assistance to the financial organization for creating the custom implementation of the generic onboarding system.

17. A non-transitory computer-readable storage medium encoding computer executable instructions that, when executed by at least one processor, performs a method for configuring user onboarding in a financial organization, the method comprising:
enabling, at a generic onboarding system, the financial organization to select a set of rules from a plurality of rules, wherein the plurality of rules is a combination of one or more type of user onboarding rules, wherein the set of rules are selected based on financial service to be provided by the financial organization, wherein the set of rules are selected by the financial organization in real time and dynamically, wherein the financial organization selects the set of rules on one or more input sources;
receiving, at the generic onboarding system, the set of rules associated with the financial organization, wherein the set of rules are evaluated for user onboarding on a platform associated with the financial organization, wherein the user is onboarded on the platform for the financial service requested by the user, wherein the set of rules are received from the one or more input sources;
enabling, at the generic onboarding system, automation of onboarding process for the user on the platform associated with the financial organization, wherein the automation is enabled using an execution engine associated with the generic onboarding system, wherein the execution engine executes the set of rules of associated with the financial organization, wherein the execution engine follows a custom flow for execution of the set of rules selected by the financial organization, wherein the custom flow is a sequence for implementation of the set of rules;
performing, at the generic onboarding system, a set of actions by a decision engine, wherein the decision engine evaluates one or more user documents corresponding to the set of rules selected by the financial organization, wherein the decision engine generates a risk score report corresponding to the user based on the evaluation of the one or more user documents, wherein the risk score report is generated using one or more hardware run algorithms; and
rendering, at the generic onboarding system, a decision taken by the decision engine for onboarding the user on the platform associated with the financial organization, wherein the decision comprises one of safe, unsafe or risky based on the evaluation of the one or more user documents, wherein the set of actions comprises one of onboarding user, rejecting user and flagging user.

18. The non-transitory computer readable storage medium as claimed in claim 17, wherein the generic onboarding system reduces the turnaround time and onboarding cost for user onboarding on the platform associated with the financial organization, wherein the turnaround time and cost for user onboarding is reduced by automating the user onboarding process.

19. The non-transitory computer readable storage medium as claimed in claim 17, wherein the generic onboarding system provides an interface to the financial organization for interacting with the generic onboarding system using a virtual assistant, wherein the virtual assistant provides complete assistance to the financial organization for creating the custom implementation of the generic onboarding system.

20. The non-transitory computer readable storage medium as claimed in claim 17, wherein the plurality of rules comprising at least one of a first set of rules, a second set of rules and a third set of rules.
